(19) United States
(12) Patent Application Publication
(10) Pub. No.: US 2018/0025479 A1
(43) Pub. Date: Jan. 25, 2018

(54) SYSTEMS AND METHODS FOR ALIGNING MEASUREMENT DATA TO REFERENCE DATA

(71) Applicant: Toyota Motor Engineering & Manufacturing North America, Inc., Erlanger, KY (US)

(72) Inventor: Aaron Burton, Fort Wright, KY (US)

(73) Assignee: Toyota Motor Engineering & Manufacturing North America, Inc., Erlanger, KY (US)

(21) Appl. No.: 15/214,490

(22) Filed: Jul. 20, 2016

(51) Int. Cl. G06T 7/00; G06T 17/20; G06F 17/50; G06T 7/60

(52) U.S. Cl. CPC G06T 7/001; G06T 7/60; G06T 17/20; G06F 17/50; G06T 2207/10004

(57) ABSTRACT

Systems and methods for evaluating a manufactured part to determine whether the shape of the manufactured part corresponds to an expected shape are described. A method to evaluate the manufactured part includes generating a point cloud of the manufactured part from measurement data relating to the manufactured part, generating a mesh including a plurality of nodes from the point cloud, and determining a normal vector slope, a local second order derivative, and a local third order derivative for each node. The normal vector slope, the local second order derivative, and the local third order derivative at each node provides an angle of curvature at a location on the manufactured part. The method further includes comparing the angle of curvature at the location on the manufactured part with reference data for a nominal part that is representative of one or more expected dimensions of the manufactured part.

### TECHNICAL FIELD

The present specification generally relates to aligning measurement data to reference data and, more specifically, to systems and methods that improve alignment between an image of a target object and a reference file containing dimensional information regarding the target object.

### BACKGROUND

Tight control of the dimensional aspects of a manufactured part is particularly necessary in instances where the manufactured part contains a surface that is easily visible to an observer when installed (“class A surface”), such as, for example, a vehicle body panel, a dashboard panel, or the like. For example, tight control of the dimensional aspects of a manufactured part containing a visible surface may be maintained to ensure that an observer, when viewing the installed manufactured part sees a smooth surface as it was intended when designed.

Existing techniques evaluate the dimensional aspects of a manufactured part by obtaining one or more measurements (e.g., completing a 3 dimensional scan of the part), obtaining reference data for the manufactured part (e.g., computer-aided design (CAD) data for the part), and evaluate the measurements for best fit based on x, y, z error minimization methods. However, such techniques cannot identify the source of geometry deviations, such as curves, at the class A surface.

Accordingly, a need exists for systems and methods that can accurately pinpoint the source of geometry deviations in class A surfaces such that those deviations can be appropriately corrected.

### SUMMARY

In one embodiment, a method to evaluate a manufactured part includes generating, by a processing device, a point cloud of the manufactured part from measurement data relating to the manufactured part, generating, by the processing device, a mesh from the point cloud of the manufactured part, the mesh including a plurality of nodes, and determining, by the processing device, a normal vector slope, a local second order derivative, and a local third order derivative for each node of the plurality of nodes. The normal vector slope, the local second order derivative, and the local third order derivative at each node provides an angle of curvature at a location on the manufactured part. The method further includes comparing, by the processing device, the angle of curvature at the location on the manufactured part with reference data for a nominal part that is representative of one or more expected dimensions of the manufactured part.

In another embodiment, a system to evaluate a manufactured part includes a processing device and a non-transitory, processor-readable storage medium. The non-transitory, processor-readable storage medium comprising one or more programming instructions that, when executed, cause the processing device to generate a point cloud of the manufactured part from measurement data relating to the manufactured part, generate a mesh from the point cloud of the manufactured part, wherein the mesh comprises a plurality of nodes, determine a normal vector slope, a local second order derivative, and a local third order derivative for each node of the plurality of nodes, wherein the normal vector slope, the local second order derivative, and the local third order derivative at each node provides an angle of curvature at a location on the manufactured part, and compare the angle of curvature at the location on the manufactured part with reference data for a nominal part that is representative of one or more expected dimensions of the manufactured part.

In yet another embodiment, a system to evaluate a manufactured part includes a measuring device, a processing device communicatively coupled to the measuring device, and a non-transitory, processor-readable storage medium. The non-transitory, processor-readable storage medium comprising one or more programming instructions that, when executed, cause the processing device to receive measurement data relating to the manufactured part from the measuring device, generate a point cloud of the manufactured part from the measurement data, generate a mesh from the point cloud of the manufactured part, the mesh having a plurality of nodes, and determine a normal vector slope, a local second order derivative, and a local third order derivative for each node of the plurality of nodes. The normal vector slope, the local second order derivative, and the local third order derivative at each node provides an angle of curvature at a location on the manufactured part. The programming instructions, when executed, further determine a plurality of reference points on a nominal part that correspond to the plurality of nodes, where the nominal part is representative of one or more expected dimensions of the manufactured part, determine a normal vector slope, a local second order derivative, and local third order derivative for each reference point of the plurality of reference points, where the normal vector slope, the local second order derivative, and the local third order derivative at each reference point provides reference data for the nominal part, and compare the angle of curvature at the location on the manufactured part with the reference data.

These and additional features provided by the embodiments described herein will be more fully understood in view of the following detailed description, in conjunction with the drawings.

### BRIEF DESCRIPTION OF THE DRAWINGS

The embodiments set forth in the drawings are illustrative and exemplary in nature and not intended to limit the subject matter defined by the claims. The following detailed description of the illustrative embodiments can be understood when read in conjunction with the following drawings, where like structure is indicated with like reference numerals and in which:

FIG. 1A depicts an illustrative shape of a manufactured part according to one or more embodiments shown and described herein;

FIG. 1B depicts an illustrative nominal shape of a manufactured part according to one or more embodiments shown and described herein;

FIG. 1C schematically depicts error evaluation of a shape of a manufactured part based on a nominal shape according to one or more embodiments shown and described herein;

FIG. 1D schematically depicts error evaluation of a shape of a manufactured part based on a nominal shape via second and third order derivative alignment according to one or more embodiments shown and described herein;

FIG. 2 schematically depicts an illustrative computing network for a system to estimate a pose of a textureless object according to one or more embodiments shown and described herein;

FIG. 3A schematically depicts a block diagram of illustrative hardware of a computing device that is used to estimate a pose of a textureless object according to one or more embodiments shown and described herein;

FIG. 3B schematically depicts a block diagram of software modules contained within a memory of a computing device that is used to estimate a pose of a textureless object according to one or more embodiments shown and described herein;

FIG. 3C schematically depicts a block diagram of various data contained within a data storage component of a computing device that is used to estimate a pose of a textureless object according to one or more embodiments shown and described herein;

FIG. 4 depicts a flow diagram of an illustrative method of evaluating a manufactured part according to one or more embodiments shown and described herein;

FIG. 5A schematically depicts an illustrative point cloud generated for a manufactured part according to one or more embodiments shown and described herein;

FIG. 5B schematically depicts an illustrative mesh generated for a manufactured part according to one or more embodiments shown and described herein;

FIG. 5C schematically depicts a plurality of slopes of an illustrative mesh generated for a manufactured part according to one or more embodiments shown and described herein;

FIG. 6A schematically depicts a rendering of a nominal part using reference data according to one or more embodiments shown and described herein; and

FIG. 6B schematically depicts a plurality of slopes of a rendering of a nominal part using reference data according to one or more embodiments shown and described herein.

### DETAILED DESCRIPTION

The embodiments described herein are generally directed to systems and methods for imaging a target object, such as a manufactured part or the like, and verifying dimensional aspects of the target object by comparing areas of curvature with reference data corresponding to the target object. The systems and methods create a mesh from the imaged manufactured part and determine a normal vector slope, a local second order derivative, and a local third order derivative for one or more nodes on the mesh to determine a curvature of the part at a location that corresponds to each of the one or more nodes. This information is compared with a normal vector slope, a local second order derivative, and a local third order derivative of corresponding areas in the reference data, which results in a more accurate comparison of the manufactured part with the reference data. In addition, the systems and methods described herein can determine changes that are necessary to bring the manufactured part more in compliance with the shape defined by the reference data, such as a transformation matrix or the like.

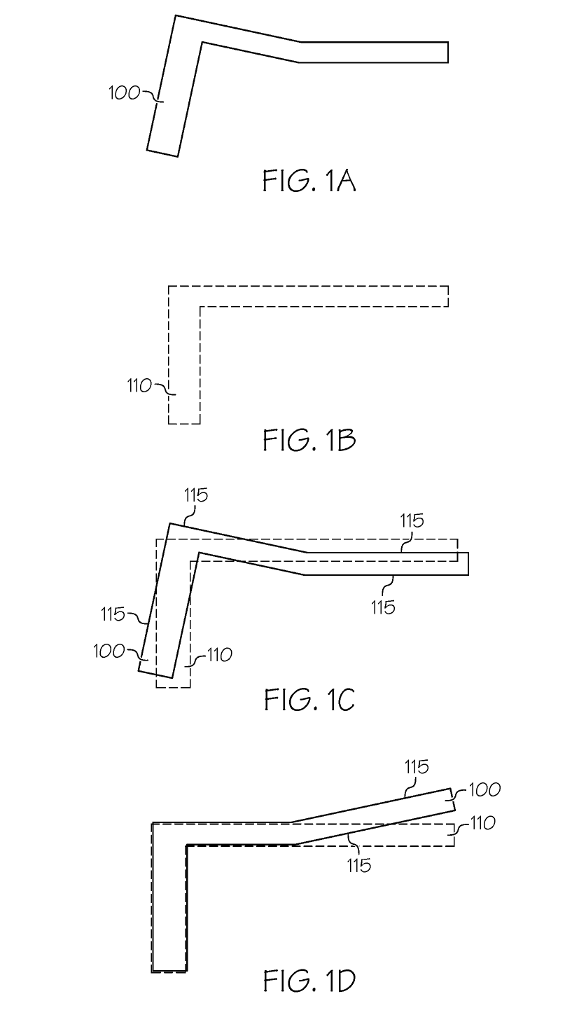

The systems and methods provide a means of ensuring a manufactured part accurately fits within all of the dimensional parameters specified in reference data (e.g., CAD data or the like). This is achieved by verifying the curvature of the manufactured part at one or more locations instead of just verifying that a point on the manufactured part is within specified limits on x, y, and z planes, as a target object may be within specified limits on x, y, and z planes, but may have an incorrect curvature, which may result in a surface that is not aesthetically pleasing. For example, as shown in FIG. 1A, an illustrative manufactured part 100 may have a portion where the curvature does not match up to a curvature of a nominal part 110, as shown in FIG. 1B. When the manufactured part 100 is overlaid on the nominal part 110 as shown in FIG. 1C, verifying the shape of the manufactured part 100 using x, y, z evaluation will result in inaccurate surfaces 115 of the manufactured part 100 not appropriately overlaid with the nominal part 110 (i.e., the curvature is not accounted for). However, if the curvature of the surface of the manufactured part is calculated as described herein, it results in the inaccurate surfaces 115 of the manufactured part 100 being more aligned with the nominal part 110 in such a manner that the error can be better localized and appropriate error correction can be taken, as shown in FIG. 1D.

As used herein, a “point cloud” is a set of points or vertices in a three dimensional (3D) coordinate system. Such vertices may be defined by x, y, and z coordinates, and can represent the external surface of a target object, such as a manufactured part or the like. 3D point clouds or models can be generated or constructed using any technique now known or later developed. In a nonlimiting example, a point cloud may be created by 3D scanners, including laser-based scanners, LIDAR systems, and/or the like. In another nonlimiting example, a point cloud may be created via stereo imaging, where multiple images of a scene are used to construct pixel or point-based depth maps of scenes or objects in a scene. In general, 3D scanners process objects to identify large numbers of surface points on the object to produce a 3D point cloud representing the object surface.

As used herein, a “mesh” is collection of vertices, edges, and faces that define the shape of an object in 3D computer graphics and solid modeling. The mesh may be a polygon mesh or a triangle mesh. The mesh may be used by computer software programs and hardware devices by completing mapping operations on the vertices at the corners of shapes used for the mesh (e.g., triangles). For the purposes of the present disclosure, the mesh may be generated from a point cloud, as the point cloud by itself may not be usable by computer software programs and hardware devices for the purposes of determining a curvature of a surface.

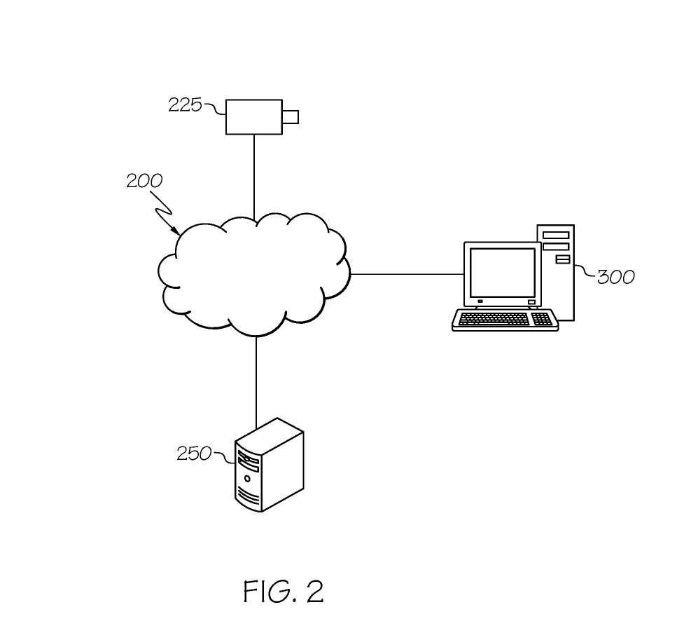

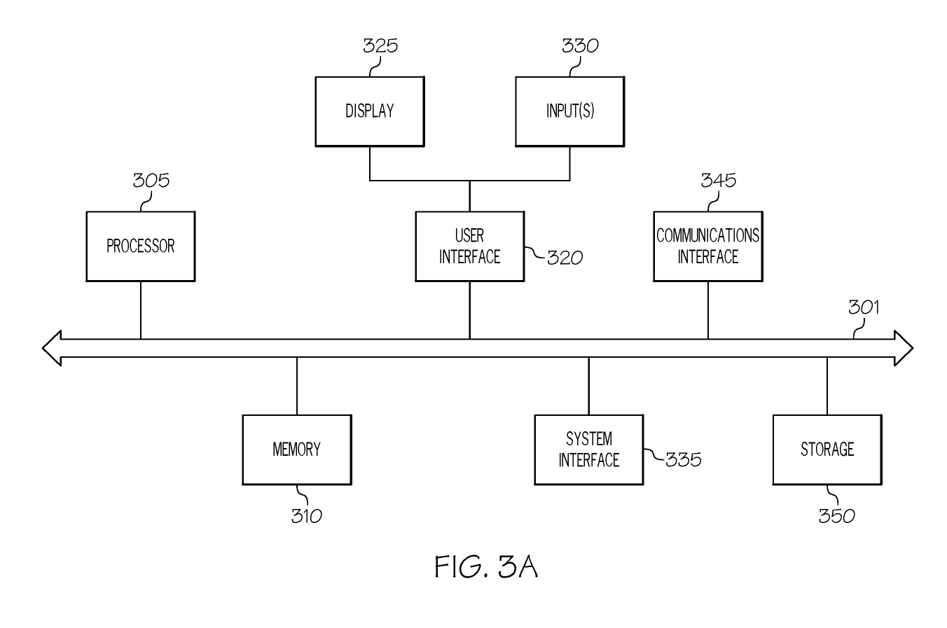

FIG. 2 depicts an illustrative computing network that depicts components for a system that evaluates a manufactured part, according to embodiments shown and described herein. As illustrated in FIG. 2, a computer network 200 may include a wide area network (WAN), such as the Internet, a local area network (LAN), a mobile communications network, a public service telephone network (PSTN), a personal area network (PAN), a metropolitan area network (MAN), a virtual private network (VPN), and/or another network. The computer network 200 may generally be configured to electronically connect one or more computing devices and/or components thereof, and/or one or more imaging devices. Illustrative computing devices may include, but are not limited to, a user computing device 300 and a server computing device 250. An illustrative imaging device may include, but is not limited to, an imaging device 225 configured to capture one or more images and/or measurements of an object, such as a manufactured part, as described in greater detail herein. In some embodiments, the user computing device 300 and the imaging device 225 may be separate devices or may be integrated into a single device.

The imaging device 225 is not limited by this disclosure, and may each generally be any device that captures images, captures image-related data (e.g., raw scan data), obtains measurements, generates a point cloud, and/or transmits image, measurement, and/or point cloud related data. In some embodiments, the imaging device 225 may be an imaging device that is specifically configured for obtaining measurements (e.g., a measuring device). One nonlimiting example of a measuring device may be an optical measuring device that produces pulsed light directed at the target object and measures the amount of light that is reflected off the target object to determine the dimensional aspects of the target object. In some embodiment, the imaging device 225 may be a 3D scanner, including a laser-based scanner, a LIDAR system, and/or the like. In some embodiments, the imaging device 225 may be a camera, a camcorder, or the like, and may incorporate one or more image sensors, one or more image processors, one or more optical elements, and/or the like. The imaging device 225 may be capable of zooming in and out and may further be capable of moving, such as, for example, panning, tilting, moving along a guide, and/or the like.

While a single imaging device 225 is depicted herein, the number of imaging devices is not limited by this disclosure and may generally be any number of imaging devices. For example, a plurality of imaging devices may be used to capture various angles of a target object, such as a manufactured part. In another example, a single imaging device 225 may be used to capture various angles of a target object by moving relative to the target object.

In various embodiments, the imaging device 225 may be positioned adjacent to a target object to be imaged, such as a manufactured part or the like. The imaging device 225 may generally be positioned such that a field of view of the imaging device 225 captures at least a portion of the target object. For example, in embodiments where a plurality of imaging devices are used, each of the plurality of imaging devices may have its own optical axis. In addition, each individual imaging device is oriented such that each respective optical axis is at a different angle relative to the target object. In another example, in embodiments where the a single imaging device is used, the imaging device may have an optical axis and movement (e.g., rotation) of the imaging device causes the optical axis to continuously reorient at a plurality of different angles relative to the target object.

The imaging device 225 may be mounted to any stationary or moving apparatus that provides the imaging device 225 with the capability of imaging the target object as described herein. For example, the imaging device 225 may be coupled to an arm or other support that allows the imaging device 225 to move about an axis around the target object such that the imaging device 225 can capture any angle of the target object. In some embodiments, movement of the imaging device 225 may be remotely controlled by a user.

The user computing device 300 may generally be used as an interface between a user the other components connected to the computer network 200, and/or various other components communicatively coupled to the user computing device 300 (such as components communicatively coupled via one or more networks to the user computing device 300), whether or not specifically described herein. Thus, the user computing device 300 may be used to perform one or more user-facing functions, such as receiving one or more inputs from a user or providing information to the user. Additionally, in the event that the server computing device 250 requires oversight, updating, or correction, the user computing device 300 may be configured to provide the desired oversight, updating, and/or correction. The user computing device 300 may also be used to input additional data into a data storage portion of the server computer device 250.

The server computing device 250 may receive electronic data and/or the like from one or more sources (e.g., the imaging device 225, the user computing device 300, and/or one or more databases), direct operation of one or more other devices (e.g., the imaging device 225), generate a point cloud and a mesh of an imaged object, determine a curvature of an imaged object from the mesh, determine a difference between an actual and an expected curvature, and/or determine a means for minimizing the difference between the actual and the expected curvature. In some embodiments, the server computing device 250 may direct the imaging device 225 to move relative to a target object, direct the imaging device 225 to zoom in or out on a target object, and/or direct the imaging device 225 to capture one or more images of a target object, as described in greater detail herein.

It should be understood that while the user computing device 300 is depicted as a personal computer and the server computing device 250 is depicted as a server, these are nonlimiting examples. More specifically, in some embodiments, any type of computing device (e.g., mobile computing device, personal computer, server, etc.) may be used for any of these components. Additionally, while each of these computing devices is illustrated in FIG. 2 as a single piece of hardware, this is also merely an example. More specifically, each of the user computing device 300 and the server computing device 250 may represent a plurality of computers, servers, databases, components, and/or the like.

In addition, it should be understood that while the embodiments depicted herein refer to a network of computing devices, the present disclosure is not solely limited to such a network. For example, in some embodiments, the various processes described herein may be completed by a single computing device, such as a non-networked computing device or a networked computing device that does not use the network to complete the various processes described herein.

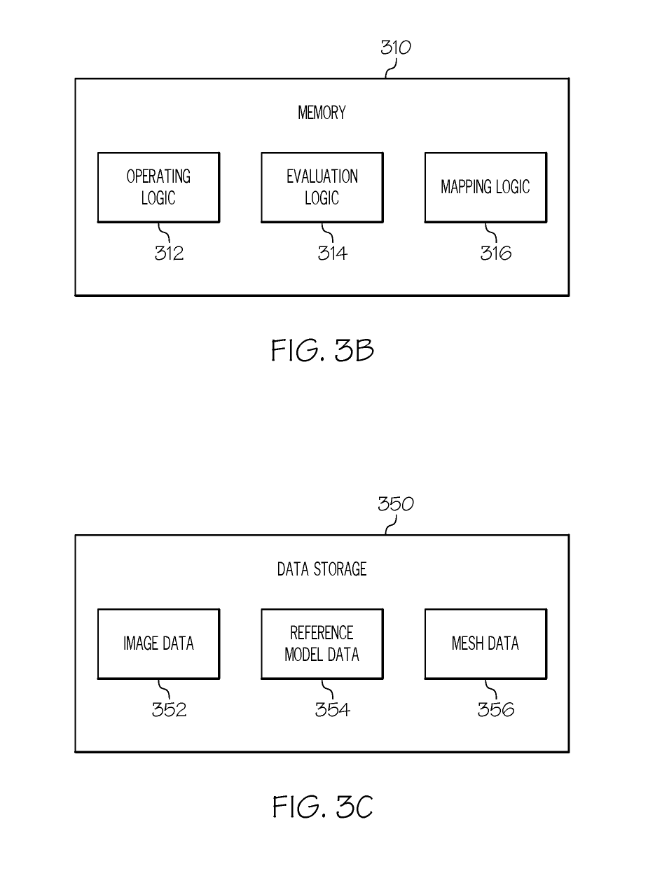

Illustrative hardware components of the user computing device 300 and/or the server computing device 250 are depicted in FIG. 3A. A bus 301 may interconnect the various components. A processing device 305, such as a computer processing unit (CPU), may be the central processing unit of the computing device, performing calculations and logic operations required to execute a program. The processing device 305, alone or in conjunction with one or more of the other elements disclosed in FIG. 3A, is an illustrative processing device, computing device, processor, or combination thereof, as such terms are used within this disclosure. Memory 310, such as read only memory (ROM) and random access memory (RAM), may constitute an illustrative memory device (i.e., a non-transitory processor-readable storage medium). Such memory 310 may include one or more programming instructions thereon that, when executed by the processing device 305, cause the processing device 305 to complete various processes, such as the processes described herein. Optionally, the program instructions may be stored on a tangible computer-readable medium such as a compact disc, a digital disk, flash memory, a memory card, a USB drive, an optical disc storage medium, such as a Blu-ray™ disc, and/or other non-transitory processor-readable storage media.

In some embodiments, the program instructions contained on the memory 310 may be embodied as a plurality of software modules, where each module provides programming instructions for completing one or more tasks. For example, as shown in FIG. 3B, the memory 310 may contain operating logic 312, evaluation logic 314, and/or mapping logic 316. The operating logic 312 may include an operating system and/or other software for managing components of a computing device. The evaluation logic 314 may include one or more software modules for obtaining one or more images of a manufactured object and/or reference data, generating a point cloud and/or a mesh from the one or more images and/or the reference data, and/or determining a normal vector slope, a local second order derivative, and a local third order derivative from one or more nodes on the mesh. The mapping logic 316 may include one or more software modules for evaluating an imaged manufactured part, comparing slopes of various points on an imaged manufactured part with a nominal shape obtained from reference data, and/or determining a transformation necessary to ensure a manufactured part is within a range of acceptable measurements with respect to a nominal shape obtained from reference data.

Referring again to FIG. 3A, a storage device 350, which may generally be a storage medium that is separate from the memory 310, may contain one or more data repositories for storing data that is used for evaluating a manufactured part and/or determining a manufactured part transformation. The storage device 350 may be any physical storage medium, including, but not limited to, a hard disk drive (HDD), memory, removable storage, and/or the like. While the storage device 350 is depicted as a local device, it should be understood that the storage device 350 may be a remote storage device, such as, for example, a server computing device or the like.

Illustrative data that may be contained within the storage device 350 is depicted in FIG. 3C. As shown in FIG. 3C, the storage device 350 may include, for example, image data 352, reference model data 354, and/or mesh data 356. Image data 352 may include, for example, images that are collected of a target object (e.g., a manufactured part) and are subsequently used for evaluation, and/or the like. Reference model data 354 may include, for example, data relating to a nominal part, including a shape of the nominal part, a curvature of the nominal object at one or more locations, and/or the like. The data may be any type of reference data, such as CAD data or the like. Mesh data 356 may include, for example, data generated as the result of generating a point cloud and/or a mesh of an imaged object, a nominal part, and/or the like, as described in greater detail herein.

Referring again to FIG. 3A, an optional user interface 320 may permit information from the bus 301 to be displayed on a display 325 portion of the computing device in audio, visual, graphic, or alphanumeric format. Moreover, the user interface 320 may also include one or more inputs 330 that allow for transmission to and receipt of data from input devices such as a keyboard, a mouse, a joystick, a touch screen, a remote control, a pointing device, a video input device, an audio input device, a haptic feedback device, and/or the like. Such a user interface 320 may be used, for example, to allow a user to interact with the computing device or any component thereof.

A system interface 335 may generally provide the computing device with an ability to interface with one or more of the components of the computer network 200 (FIG. 2), such as, for example, the imaging device 225. Communication with such components may occur using various communication ports (not shown). An illustrative communication port may be attached to a communications network, such as the Internet, an intranet, a local network, a direct connection, and/or the like.

A communications interface 345 may generally provide the computing device with an ability to interface with one or more external components, such as, for example, an external computing device, a remote server, and/or the like. Communication with external devices may occur using various communication ports (not shown). An illustrative communication port may be attached to a communications network, such as the Internet, an intranet, a local network, a direct connection, and/or the like.

It should be understood that the components illustrated in FIGS. 3A-3C are merely illustrative and are not intended to limit the scope of this disclosure. More specifically, while the components in FIGS. 3A-3C are illustrated as residing within the server computing device 250 or the user computing device 300, these are nonlimiting examples. In some embodiments, one or more of the components may reside external to the server computing device 250 and/or the user computing device 300. Similarly, one or more of the components may be embodied in other computing devices not specifically described herein.

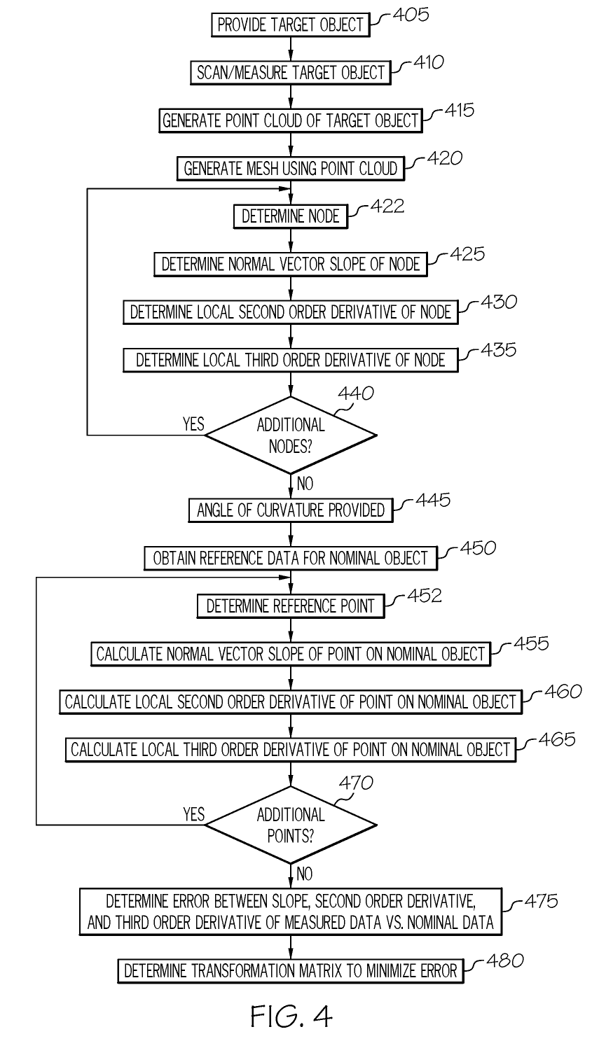

Referring now to FIG. 4, a method of evaluating a target object, such as a manufactured part, is described. At step 405, the target object to be imaged is provided. For example, a manufactured part having at least one class A surface, such as a body panel, a dashboard panel, or the like, may be provided in accordance with step 405.

At step 410, the provided target object may be scanned and/or measured. That is, an imaging device or the like may be directed to obtain one or more images of the target object or may be directed to obtain one or more measurements of the target object. For example, certain imaging devices may obtain a plurality of images, which are then measured, to determine the one or more dimensions of the target object. In another example, certain imaging devices (such as optical measuring devices or the like) may be directed to pulse a laser and receive reflected light, which, in turn, provides measurement data corresponding to the one or more dimensions of the target object.

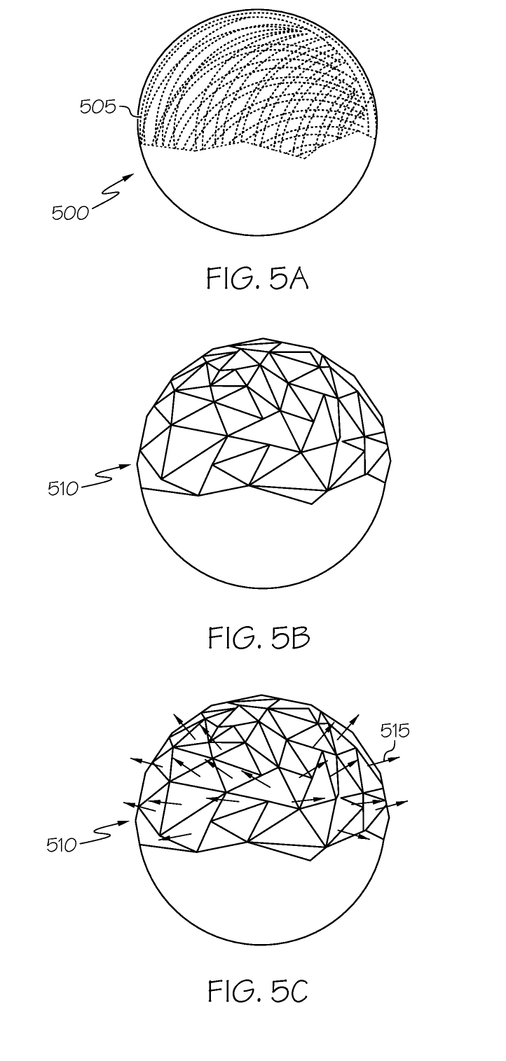

At step 415, a point cloud of the target object is generated. That is, the data from the images/measurements is used to plot a plurality of points/vertices representing the surface of the target object in 3D space. FIG. 5A depicts an illustrative point cloud 505 of a target object 500. As shown in FIG. 5A, each one of the points of the point cloud 505 correspond to points on the imaged object in 3D space. In some embodiments, the point cloud may be generated by the imaging device (such as a laser based scanner, a LIDAR system, and/or the like) and transmitted to an external processing device for the purposes of generating a mesh, as described herein. In other embodiments, the point cloud may be generated by a processing device upon receiving image and/or measurement data from an imaging device, such as by translating the image and/or measurement data into point cloud data. In some embodiments, generating a point cloud may further include storing point cloud data in a data storage device, such as the data storage devices described herein. The point cloud data may be stored as a point cloud data file, for example.

Referring again to FIG. 4, at step 420, a mesh may be generated from the point cloud. The mesh may be generated using any mesh construction methods now known or later developed. In a nonlimiting example, the mesh may be generated by constructing the mesh using a Poisson reconstruction method. In another nonlimiting example, the mesh may be generating by feeding the point cloud data into a conversion software module, such as, but not limited to, MeshLab (Visual Computing Lab ISTI-CNR, Pisa, Italy), Inkscape, 3-Matic (Materialise NV, Leuven, Belgium), Magics (Materialise NV, Leuven, Belgium), and/or the like. The conversion software module then converts point cloud data into a mesh using one or more conversion algorithms.

An illustrative example of a mesh that may be generated from the point cloud is depicted in FIG. 5B. As shown in FIG. 5B, the mesh 510 includes a plurality of vertices, edges, and faces to model the shape of the imaged object. In some embodiments, at least one vertex of the mesh 510 may represent a node for which a curvature is determined. In addition, the mesh 510 depicted in FIG. 5 is a triangle mesh. However, it should be understood that other meshes may also be used without departing from the scope of the present disclosure.

Upon creation of the mesh, the curvature of the target object can be determined using the data from the mesh. Referring again to FIG. 4, the curvature may be determined by determining a node of the mesh at step 422, determining the normal vector slope of the node at step 425, determining a local second order derivative (e.g., a second derivative) of the node at step 430, and determining a local third order derivative (e.g., a third derivative) of the node at step 435. In addition, a determination is made at step 440 as to whether additional nodes for determining the curvature are needed/present. If so, steps 422-435 are repeated until no additional nodes exist.

Determining a node at step 422 generally includes selecting a point on the mesh for which a curvature of the corresponding target object is to be determined. The point on the mesh is not limited by this disclosure, and may be, for example, one of the plurality of vertices of the mesh. However, it should be understood that other points may also be selected without departing from the scope of the present disclosure.

Determining the normal vector slope at step 425 includes determining (e.g., calculating) a slope of a vector that extends perpendicularly from the surface of the mesh (and thus the imaged target object) at a specific node that was selected according to step 422. More specifically, the normal vector (also referred to as a “normal”) is a vector that extends perpendicularly from the tangent plane of the surface of the mesh (and the target object) at the node. As should be understood, determining the slope of the normal vector includes calculating the derivative of a function for the normal vector. That is, a function of y=ƒ(x) has a derivative with the notation

$$\frac{dy}{dx} .$$

FIG. 5C illustrates a plurality of normals 515 to a surface of the mesh 510 at particular nodes. As shown in FIG. 5C, each normal of the plurality of normals 515 extends outwardly from the surface of the mesh 510 perpendicularly from the tangent plane of the surface at a particular node corresponding to the normal.

Referring again to FIG. 4, determining the local second order derivative at step 430 includes determining (e.g., calculating) a derivative of the derivative of the function for the normal vector. Continuing from the example provided above, it should be understood that a function of y=ƒ(x) has a second order derivative with the notation

$$\frac{{d}^{2} y}{{dx}^{2}} .$$

As a result of calculating the local second order derivative, a rate of change of the slope of the vector that extends perpendicularly from the node may be provided.

Determining the local third order derivative at step 435 includes determining (e.g., calculating) a derivative of the derivative of the derivative of the function for the normal vector. Continuing from the examples provided above, it should be understood that a function of y=ƒ(x) has a third order derivative with the notation

$$\frac{{d}^{3} y}{{dx}^{3}} .$$

As a result of determining the local third order derivative, a rate of change of the rate of change of the slope of the vector that extends perpendicularly from the node may be provided. As a result, the torsion of the curve (e.g., the fundamental property of the curve in three dimensions) of the surface of the target object is determined, which, in turn, accurately defines an angle of curvature of the target object at the node.

As previously described herein, steps 422-435 may be repeated for each additional node for which the determinations of normal vector slope, second order derivative, and third order derivative are completed. As such, a determination is made at step 440 as to whether additional nodes exist. Such a determination may be made, for example, based on a minimum number of nodes needed to determine a curvature of particular areas of a target object, such as class A surfaces or the like. If additional nodes exist, the process may return to step 422. Otherwise, the process moves to step 445.

At step 445, the angle of curvature of the surface of the target object is provided based on the calculations that are completed in steps 422-435. Similar calculations are then completed for a nominal object, such as a reference object upon which the target object is based (e.g., a nominal part). For example, the nominal object may be a virtual rendering of an object created from reference data, such as CAD data or the like. The reference data may be the same data that is used for manufacturing the target object. As such, the target object should theoretically match the various dimensions provided by the reference data, and thus also match the virtual rendering thereof.

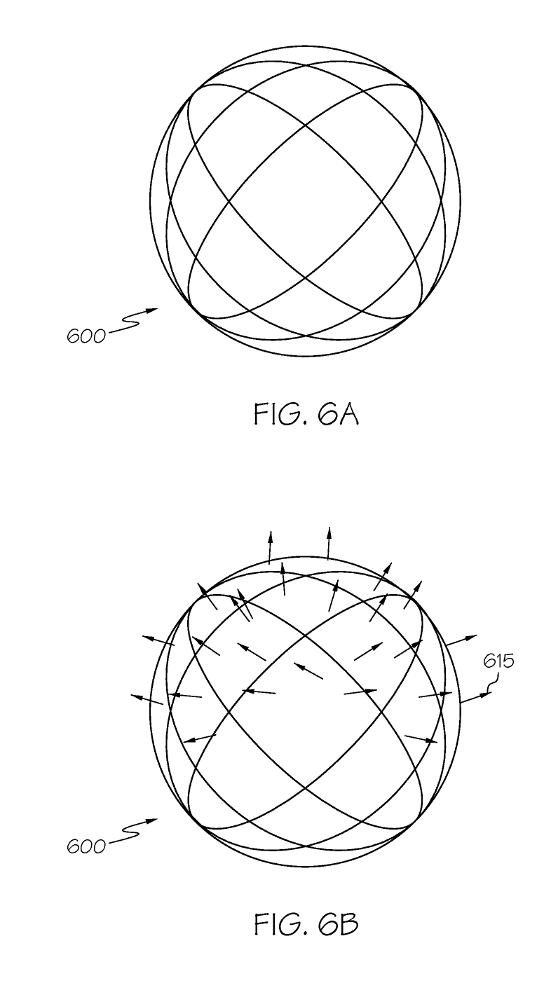

To determine whether the various measured dimensions of the target object match the dimensions provided by the reference data, the reference data of the nominal object is obtained in step 450. The reference data may be obtained via data transfer from a data repository, such as one of the data repositories described herein. In some embodiments, the reference data that is obtained may be the same reference data that is used to construct the target object (e.g., the manufactured part). That is, the reference data that is obtained in accordance with step 450 contains the exact specifications that are used to construct the target object. In a nonlimiting example, the reference data may include an electronically constructed nominal object, such as the nominal part 600 depicted in FIG. 6A. The nominal part 600 is generally a virtual rendering of what the target object should look like, including curvature of the one or more surfaces thereof, particularly any class A surfaces.

Once the reference data has been obtained, the curvature of the one or more surfaces of the nominal object defined by the reference data can be determined. Referring again to FIG. 4, the curvature may be determining a reference point on the nominal object at step 452, determining the normal vector slope of the point at step 455, determining a local second order derivative (e.g., a second derivative) of the point at step 460, and determining a local third order derivative (e.g., a third derivative) of the point at step 465. In addition, a determination may be made at step 470 as to whether additional reference points are needed/present. If so, steps 452-465 are repeated until no additional nodes exist.

Determining a reference point at step 452 generally includes selecting a point on the nominal object for which a curvature is to be determined. In some embodiments, the point may correspond to a particular node on the mesh generated according to step 420. That is, the point is at a location on the nominal object that corresponds to a similar location on the target object for which node on the mesh created from the target object exists. However, it should be understood that other points may also be selected without departing from the scope of the present disclosure.

Determining the normal vector slope at step 455 includes determining (e.g., calculating) a slope of a vector that extends perpendicularly from the surface of the nominal object at a specific point that was selected according to step 452. More specifically, the normal vector (also referred to as a “normal”) is a vector that extends perpendicularly from the tangent plane of the surface of the nominal object at the point. As should be understood, determining the slope of the normal vector includes calculating the derivative of a function for the normal vector. That is, a function of y=ƒ(x) has a derivative with the notation

$$\frac{dy}{dx} .$$

FIG. 6B illustrates a plurality of normals 615 to a surface of the nominal part 600 at particular points. As shown in FIG. 6B, each normal of the plurality of normals 615 extends outwardly from the surface of the nominal part 600 perpendicularly from the tangent plane of the surface at the particular point corresponding to the normal.

Referring again to FIG. 4, determining the local second order derivative at step 460 includes determining (e.g., calculating) a derivative of the derivative of the function for the normal vector. Continuing from the example provided above, it should be understood that a function of y=ƒ(x) has a second order derivative with the notation

$$\frac{{d}^{2} y}{{dx}^{2}} .$$

As a result of calculating the local second order derivative, a rate of change of the slope of the vector that extends perpendicularly from the point may be provided.

Determining the local third order derivative at step 465 includes determining (e.g., calculating) a derivative of the derivative of the derivative of the function for the normal vector. Continuing from the examples provided above, it should be understood that a function of y=ƒ(x) has a third order derivative with the notation

$$\frac{{d}^{3} y}{{dx}^{3}} .$$

As a result of determining the local third order derivative, a rate of change of the rate of change of the slope of the vector that extends perpendicularly from the point may be provided. As a result, the torsion of the curve (e.g., the fundamental property of the curve in three dimensions) of the surface of the nominal object is determined, which, in turn, accurately defines an angle of curvature of the nominal object at the point.

As previously described herein, steps 452-465 may be repeated for each additional point for which the determination of normal vector slope, second order derivative, and third order derivative are completed. As such, a determination is made at step 470 as to whether additional points exist. Such a determination may be made, for example, based on a minimum number of points needed to determine a curvature of particular areas of a nominal object, such as points that correspond to the nodes determined for the target object in step 422 above. If additional points exist, the process may return to step 452. Otherwise, the process moves to step 475.

At step 475, an error is determined between the normal vector slope, the second order derivative, and the third order derivative for each node on the mesh when compared to a corresponding point on the nominal object (e.g., an error between the angle of curvature at the node on the target object with a corresponding point on the nominal part generated from the reference data). That is, a presumption is made that the normal vector slope, the second order derivative, and the third order derivative of a particular point on the nominal object is correct, and the determination is made as to how much the normal vector slope, the second order derivative, and the third order derivative of a corresponding node on the mesh differ from those on the nominal object (if any). The difference may be expressed, for example, as a numerical amount (e.g., the normal vector slope differs by 0.1) and/or a percentage amount (e.g., the normal vector slope differs by 0.05%). The error may also be determined to be either within or outside a threshold amount of error. For example, if a threshold is established whereby a 0.05% difference is acceptable, any error that is less than or equal to 0.05% (e.g., within the threshold) may be considered to be acceptable, whereas any error greater than 0.05% (e.g., outside the threshold) is unacceptable. It should be understood that the percentages described above are merely illustrative, and the threshold may be represented by other percentages or numbers without departing from the scope of the present disclosure.

In some embodiments, a quality of the target object may be determined based on the determined error. That is, the target object may be considered a “high quality” object, “low quality” object, “medium quality” object, or the like, based on the amount of determined error for each of the nodes, or based on the determined error for all of the nodes as a whole. For example, a target object may be considered a “high quality” object or other similar designation if the corresponding mesh contains no nodes that are located outside of a predetermined threshold. Similarly, a target object may be considered a “low quality” object or other similar designation if the corresponding mesh contains one or more nodes that are located outside a predetermined threshold.

If an error is determined for at least one node, or if an error is determined for at least one node that is outside (e.g., greater than) a particular threshold, a heuristic may be used to determine which transformation matrix of a plurality of transformation matrices will minimize or eliminate the error at step 480. The transformation matrix may be determined for the purposes of changing the shape of the target object (e.g., altering a manufacture of a manufactured part) such that, when subsequently measured as described herein, will match (or at least fall within a threshold) of the shape defined by the reference data for the nominal object (i.e., eliminate or minimize the amount of error between the target object and the nominal object). As should generally be understood, the transformation matrix is a mathematical function for allowing linear transformations to be represented in a consistent format.

Accordingly, it should now be understood that the systems and methods described herein can measure a target object, create a mesh representing the target object, determine a normal vector slope, a local second order derivative, and a local third order derivative for one or more nodes of the mesh, and compare the determined information with corresponding information determined for a nominal object generated from reference data, such as CAD data or the like. As a result, the systems and methods described herein can more accurately determine whether the dimensional aspects of the target object accurately correspond to those of the nominal part generated from the reference data, including a curvature of certain surfaces thereof that would not otherwise accurately be determined. As a result, the target object can be modified to accurately represent the nominal object, which can result in surfaces, particularly class A surfaces, that are more aesthetically pleasing.

It is noted that the terms “substantially” and “about” may be utilized herein to represent the inherent degree of uncertainty that may be attributed to any quantitative comparison, value, measurement, or other representation. These terms are also utilized herein to represent the degree by which a quantitative representation may vary from a stated reference without resulting in a change in the basic function of the subject matter at issue.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

What is claimed is:

1. A method to evaluate a manufactured part, the method comprising:
generating, by a processing device, a point cloud of the manufactured part from measurement data relating to the manufactured part;
generating, by the processing device, a mesh from the point cloud of the manufactured part, wherein the mesh comprises a plurality of nodes;
determining, by the processing device, a normal vector slope, a local second order derivative, and a local third order derivative for each node of the plurality of nodes, wherein the normal vector slope, the local second order derivative, and the local third order derivative at each node provides an angle of curvature at a location on the manufactured part, and
comparing, by the processing device, the angle of curvature at the location on the manufactured part with reference data for a nominal part that is representative of one or more expected dimensions of the manufactured part.

2. The method of claim 1, further comprising
receiving, by the processing device, one or more images of the manufactured part from an imaging device; and
generating, by the processing device, the measurement data for the manufactured part from the one or more images.

3. The method of claim 1, further comprising:
determining, by the processing device, a plurality of reference points on the nominal part that correspond to the plurality of nodes; and
determining, by the processing device, a normal vector slope, a local second order derivative, and a local third order derivative for each reference point of the plurality of reference points, wherein the normal vector slope, the local second order derivative, and the local third order derivative at each reference point provides the reference data for the nominal part.

4. The method of claim 1, wherein the reference data comprises computer-aided design (CAD) data.

5. The method of claim 1, further comprising:
determining, by the processing device, an error between the angle of curvature at the location on the manufactured part with a corresponding portion of the reference data for the nominal part.

6. The method of claim 5, further comprising:
determining, by the processing device, a transformation matrix for altering manufacture of the manufactured part to minimize the error.

7. The method of claim 5, further comprising:
determining, by the processing device, a quality of the manufactured part based on the error.

8. The method of claim 1, wherein generating the mesh comprises generating a triangle mesh.

9. A system to evaluate a manufactured part, the system comprising:
a processing device; and
a non-transitory, processor-readable storage medium, the non-transitory, processor-readable storage medium comprising one or more programming instructions that, when executed, cause the processing device to:
generate a point cloud of the manufactured part from measurement data relating to the manufactured part,
generate a mesh from the point cloud of the manufactured part, wherein the mesh comprises a plurality of nodes,
determine a normal vector slope, a local second order derivative, and a local third order derivative for each node of the plurality of nodes, wherein the normal vector slope, the local second order derivative, and the local third order derivative at each node provides an angle of curvature at a location on the manufactured part, and
compare the angle of curvature at the location on the manufactured part with reference data for a nominal part that is representative of one or more expected dimensions of the manufactured part.

10. The system of claim 9, wherein the non-transitory, processor-readable storage medium further comprises one or more programming instructions that, when executed, cause the processing device to:
receive one or more images of the manufactured part from an imaging device; and
generate the measurement data for the manufactured part from the one or more images.

11. The system of claim 9, wherein the non-transitory, processor-readable storage medium further comprises one or more programming instructions that, when executed, cause the processing device to:
determine a plurality of reference points on the nominal part that correspond to the plurality of nodes; and
determine a normal vector slope, a local second order derivative, and a local third order derivative for each reference point of the plurality of reference points, wherein the normal vector slope, the local second order derivative, and the local third order derivative at each reference point provides the reference data for the nominal part.

12. The system of claim 9, wherein the reference data comprises computer-aided design (CAD) data.

13. The system of claim 9, wherein the non-transitory, processor-readable storage medium further comprises one or more programming instructions that, when executed, cause the processing device to:
determine an error between the angle of curvature at the location on the manufactured part with a corresponding portion of the reference data for the nominal part.

14. The system of claim 13, wherein the non-transitory, processor-readable storage medium further comprises one or more programming instructions that, when executed, cause the processing device to:
determine a transformation matrix for altering manufacture of the manufactured part to minimize the error.

15. The system of claim 13, wherein the non-transitory, processor-readable storage medium further comprises one or more programming instructions that, when executed, cause the processing device to:
determine a quality of the manufactured part based on the error.

16. The system of claim 9, wherein the one or more programming instructions that, when executed, cause the processing device to generate the mesh further cause the processing device to generate a triangle mesh.

17. A system to evaluate a manufactured part, the system comprising:
a measuring device;
a processing device communicatively coupled to the measuring device; and
a non-transitory, processor-readable storage medium, the non-transitory, processor-readable storage medium comprising one or more programming instructions that, when executed, cause the processing device to:
receive measurement data relating to the manufactured part from the measuring device,
generate a point cloud of the manufactured part from the measurement data,
generate a mesh from the point cloud of the manufactured part, wherein the mesh comprises a plurality of nodes,
determine a normal vector slope, a local second order derivative, and a local third order derivative for each node of the plurality of nodes, wherein the normal vector slope, the local second order derivative, and the local third order derivative at each node provides an angle of curvature at a location on the manufactured part,
determine a plurality of reference points on a nominal part that correspond to the plurality of nodes, wherein the nominal part is representative of one or more expected dimensions of the manufactured part,
determine a normal vector slope, a local second order derivative, and a local third order derivative for each reference point of the plurality of reference points, wherein the normal vector slope, the local second order derivative, and the local third order derivative at each reference point provides reference data for the nominal part, and
compare the angle of curvature at the location on the manufactured part with the reference data.

18. The system of claim 17, wherein the non-transitory, processor-readable storage medium further comprises one or more programming instructions that, when executed, cause the processing device to:
determine an error between the angle of curvature at the location on the manufactured part with the reference data; and
determine a transformation matrix that is used to alter manufacture of the manufactured part to minimize the error.

19. The system of claim 18, wherein the non-transitory, processor-readable storage medium further comprises one or more programming instructions that, when executed, cause the processing device to:
determine a quality of the manufactured part based on the error.

20. The system of claim 17, wherein the one or more programming instructions that, when executed, cause the processing device to generate the mesh further cause the processing device to generate a triangle mesh.
